(19) United States
(12) Patent Application Publication
(10) Pub. No.: US 2021/0197300 A1
(43) Pub. Date: Jul. 1, 2021

(54) Cutting Assemby

(71) Applicant: Genius IP Ltd, London (GB)

(72) Inventor: Teklemichael Sebhatu, London (GB)

(21) Appl. No.: 17/269,496

(22) PCT Filed: Aug. 15, 2019
(86) PCT No.: PCT/GB2019/052299

§ 371 Date: Feb. 18, 2021

(51) Int. Cl. B23D 49/11; B23D 49/00; B23D 51/16; B23D 61/00

(52) U.S. Cl. CPC B23D 49/11; B23D 61/006; B23D 51/16; B23D 49/003

(57) ABSTRACT

A cutting assembly for cutting with at least two saw blades simultaneously, includes a motion conversion means comprises: a first part and a plurality of second parts, for example a first bevel gear (30) and a plurality of second bevel gears (32). The first part is arranged for rotation about a central axis thereof and coupled to a drive means (12) for causing the rotation. The first and second parts are arranged such that the rotation of the first part in a direction of rotation causes rotation in a corresponding direction of rotation of each second part about a respective axis extending away from the central axis of the first part. The cutting assembly also includes, for each second part, a coupling means for coupling the second part to a respective cutting blade (100a-f) and including a further motion conversion means, such that the rotation of the second part causes cutting motion of the cutting blade.

### FIELD OF THE INVENTION

The invention relates to a cutting assembly for cutting with at least two saw blades simultaneously.

### BACKGROUND

Plasterboard, also known as drywall, gypsum board or wallboard, is a panel made of gypsum plaster pressed between two thick sheets of paper. Plasterboard panels are typically mounted on structural members to make interior walls and ceilings of buildings. It is sometimes necessary, particularly when a building is erected, to cut openings in plasterboard to provide access to electrical switch and outlet boxes mounted on the structural members. An opening may be cut before the plasterboard is mounted on the structural members, or it may be necessary to cut the opening while the plasterboard is in situ mounted on the structural members.

The usual process of cutting openings comprises firstly marking on the plasterboard where the opening is to be cut. Then, a workman cuts the opening using a saw. The opening typically has rough edges. This process is time consuming, typically taking a practised workman 15 to 30 minutes. The process is also error prone and typically makes a mess. Also, the saw can extend beyond the plasterboard to make contact with an object on the far side of the plasterboard from the workman. This can cause damage to the object. Since there may be electrical wiring, this also presents danger to the workman.

The inventor has previously sought patents via a patent application entitled “Converting Between Rotary and Linear Motion, and a Sawing Device”, published under number WO2013057511. This publication includes disclosure of a sawing device for cutting by simultaneous cutting action of four saw blades on a surface of an object to be cut. Each saw blade is attached to a respective blade carrying part. Each blade carrying part can move back and forth parallel to the required path of movement of the respective saw blade. A motion conversion mechanism is provided to convert rotary motion of a drive shaft to back and forth movement of each blade carrying part. The back and forth movement of each blade carrying part causes the cutting.

While this sawing device was a considerable improvement over previous sawing devices intended for the same purpose, the sawing device did not allow cutting of an aperture in plasterboard as quickly as the inventor wanted, still vibrated more than was wanted, and required more force than was wanted to push the blades into the surface of the object to be cut. In response, the inventor devised an improved sawing device, described in a patent application published under number WO2018/0831242 and setting forth a way of oscillating an array of curved blades. This publication discloses using a rotating wave-like surface to drive linear movement of a ball bearing repetitively in a slot, which drives oscillating movement of the blades. The inventor has continued to try to reduce the vibration and force required to push the blades into the surface of an object to be cut.

### SUMMARY OF THE INVENTION

In accordance with the present invention, there is provided a cutting assembly for cutting with at least two cutting blades simultaneously, comprising: a motion conversion means comprising: a first part arranged for rotation about a central axis thereof and coupled to a drive means for causing the rotation; a plurality of second parts, the first and second parts being arranged such that the rotation of the first part in a direction of rotation causes rotation of each second part about a respective axis extending away from the central axis of the first part in a corresponding direction of rotation; for each second part, a coupling means for coupling the second part to a respective cutting blade, such that the rotation of the second part causes cutting motion of the cutting blade.

Use of such a motion conversion means in which rotary motion of the first part is converted to rotary motion of such second parts in place of the corresponding motion conversion assembly disclosed in WO2018/0831242 results in considerably less vibration. When such a cutting assembly is included in a hand-held power tool, the tool is relatively easy to handle. Also, construction of the assembly is much simplified.

The first part may be a first gear and each second part may be a second gear. The first and second gears may be bevel gears, for example, the first and second gears may be straight bevel gears or spiral bevel gears. The first and second gears may also be helical gears, or the second gears may be worm gears.

The axis of each second part may extent at least partially, or entirely, radially to the central axis of the first part.

Each coupling means may comprise retaining means arranged to retain the respective cutting blade and mounted for predetermined movement, for example pivoting/rocking movement, or linear reciprocating linear movement. The coupling means may be arranged so that the rotation of the respective second part causes the predetermined movement, and the predetermined movement imparts the cutting motion to the respective cutting blade.

Each coupling means may comprise a further motion conversion means arranged to convert the rotational motion of each second part to the predetermined movement of the respective retaining means.

Each further motion conversion means may comprise a respective motion conversion member mounted for back and forth motion, for example pivoting motion. Each coupling means may also include means linking the second part and the motion conversion member such that the rotation of the respective second part causes the back and forth motion of the motion conversion member. The back and forth motion of the motion conversion member causes the predetermined movement of the retaining means.

Each linking means may comprise a first linking part, for example a cam, coupled to the second part for rotation therewith about the respective central axis of the second part, and each motion conversion member may comprise a second linking part, for example a cam follower, where the first linking part and the second linking part are respectively arranged to cooperate so that the rotation of the second part causes the back and forth movement of the respective motion conversion member.

Where the first part is a cam and the second linking part is a cam follower, the cam follower may comprise a recessed portion in the motion conversion member and the cam may extend into the recessed portion and, in use, act on surfaces in the recessed portion to cause the back and forth motion of the motion conversion member. The cam may comprise a projection coupled to the second part offset from a central axis of the second part, and a bush located around the projection. The recessed portion may in this case have a circular cross-section or an elongate cross-section. The projection, the bush and the recessed portion, where of circular cross-section, may be arranged so that the bush stays in contact with a cylindrical interior surface of the recessed portion as the projection is rotated about the second axis of the respective second part. In an alternative, the first linking part may comprise the recessed portion and the second linking part may comprise the projection and bush, wherein the bush stays in contact with a cylindrical interior surface of the recessed portion as the recessed portion is rotated about an axis of the interior surface.

Each motion conversion member may be pivotably mounted, and the back and forth motion may be pivoting motion. Alternatively, the motion conversion member may be mounted for linear reciprocating motion. In this case, the back and forth motion is the linear reciprocating motion.

Each further motion conversion means may comprise, for each coupling means, a respective pivot piece extending radially with respect to a central axis of the first part, wherein the retaining means is mounted on the pivot piece, the pivot piece being arranged to enable the predetermined movement of the retaining means. In this case the respective motion conversion member may also be pivotally mounted on the pivot piece.

The plurality of second parts may consist of two, three, four, five or six second parts.

The second parts may be angularly spaced around the first part and may be spaced each at equal angles from adjacent of the second parts.

The drive means may comprise a drive shaft coupled to the first part, such that rotation of the drive shaft causes the rotation of the first part.

The cutting assembly may further comprise a support means, wherein the first motion conversion assembly and each coupling means are mounted on the support assembly.

Each of the cutting blades may be a circular saw blade. In this case the second part is coupled to the respective circular saw blade so that the rotation of the second part causes rotation of the circular saw blade about a central axis thereof.

There may be provided a hand-held tool comprising the cutting assembly described above. Alternatively, the cutting assembly may be provided in a fixed machine, for example on a production line.

### BRIEF DESCRIPTION OF THE FIGURES

For better understanding of the present invention, embodiments will now be described, by way of example only, with reference to the accompanying Figures in which:

FIGS. 1A, 1B and 1C are respectively top, underside and side views of a cutting device in accordance with embodiments of the invention;

FIG. 2 is an exploded view of a sawing device in accordance with embodiments of the invention;

FIG. 3 is a cross-sectional view through line A-A in FIG. 1A;

FIG. 4 is a cross-sectional view through line B-B in FIG. 1A excluding the handle;

FIG. 5 is a perspective view of a part of the sawing device, namely a first bevelled gear;

FIG. 6 is a perspective view of another part of the sawing device, namely a second gear including a cam member;

FIG. 7 is a perspective view of another part of the sawing device, namely a pin for use in attaching and releasing a blade from a retaining assembly

FIG. 8 is a perspective view of a saw blade for use with the sawing device;

FIG. 9A is a perspective exploded view of parts of the sawing device for use in retaining the saw blade;

FIG. 9B is a rear view of one of the parts shown in FIG. 9A;

FIGS. 10A and 10B are respectively perspective and plan exploded views of parts of a coupling assembly;

FIGS. 11A and 11B are respectively side and perspective exploded views of parts of a coupling assembly in accordance with a variant embodiment.

### DETAILED DESCRIPTION OF EMBODIMENTS

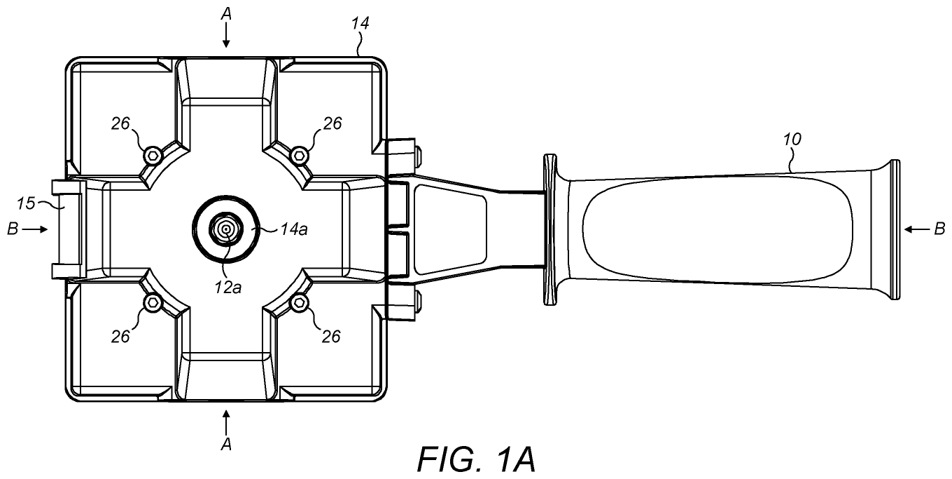

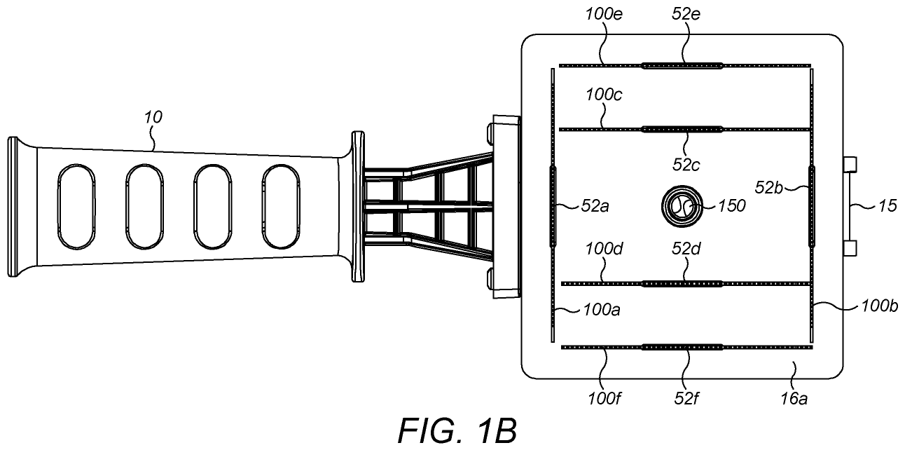

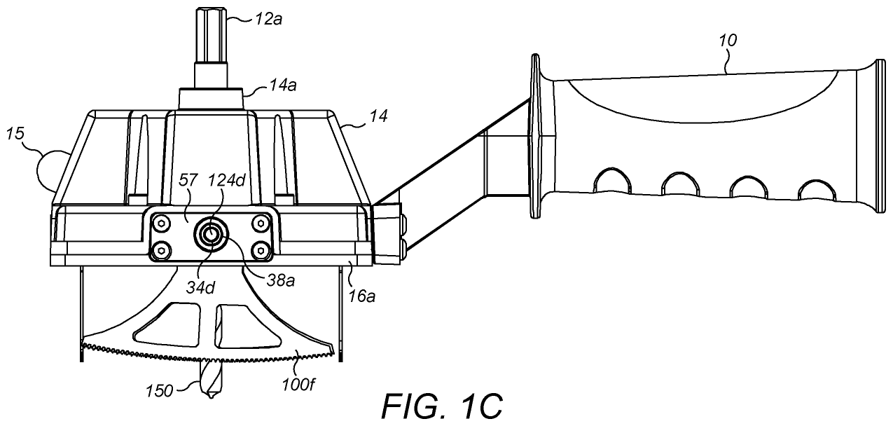

Referring to FIG. 1A to 1C, 2, 3 and 4, a sawing device is configured to cut a formation of square or rectangular cut lines in a substantially flat surface of an object, such as plasterboard, by simultaneous repetitive cutting action of four attached saw blades. The sawing device comprises a handle 10, a support structure including a housing 14, a rotary drive shaft 12, a first motion conversion assembly, four coupling assemblies, and, in use, four saw blades. The first motion conversion assembly is configured to convert rotational motion of the drive shaft 12 to rotational motion of a part of each coupling assembly, where the rotational motion of those parts is in each case about an axis radial to a central axis of the drive shaft 12. Each coupling assembly comprises a respective second motion conversion assembly and one or two blade retention assemblies. Each blade retention assembly is configured to retain a saw blade. Each second motion conversion assembly is configured to convert the rotational motion of the part of the respective coupling assembly to oscillatory motion and to impart this motion to the respective one or two blade retention assemblies, so as to cause oscillatory cutting action of retained saw blades.

The coupling assemblies together have six blade retention assemblies providing six places at which a blade can be attached. The blade retention assemblies are arranged so that the blades can be disposed to cut an arrangement of square cut lines or an arrangement of rectangular cut lines. The Figures show six blades for illustration purposes only, while only four blades may be attached when the sawing device is in use. The blades are indicated at 100a-f. Longer or shorter versions of the blade 100a, 100b may be attached depending on whether a square or rectangle is to be cut and the same reference numeral is used in both cases. Also, instead of square or rectangular holes, the sawing device enables cutting of other formations of cut lines. For example, where two or more of blades 100c, 100d, 100e and 100f are attached, a formation of parallel cut lines is produced, the number and spacing depending on the particular blades attached. Also, where two perpendicular blades are attached, a corner formation of cut lines is produced.

The support structure enables attachment and support for other of the components and includes a frame assembly comprising a first frame portion in the form of a base 16a, a second frame portion 16b and a third frame portion 16c. The support structure also includes the housing 14, as previously mentioned. The base 16a has a generally square shape, having four outer corners. The second frame portion 16b is mounted on the base 16a. The third frame portion 16c is mounted on the second frame portion 16b. The housing 14 is mounted on the base 16a and the third frame portion 16c. The base 16a has four threaded holes 18 each on a diagonal between the four outer corners, defining corners of an inner square. The second frame portion 16b, the third frame portion 16c and the housing 14 each have four through holes 20, 22, 24, one arranged to align with each of the threaded holes 18. The support structure includes, for each threaded hole 18, a bolt 26 extending through aligned through holes of the second frame portion 16b, the third frame portion 16c and the housing 14 and secured into the respective threaded hole 18 to secure the support structure together.

A first end 12a of the drive shaft 12 has a hexagonal cross-section and is configured in the same manner as an attachment part of a conventional drill bit. The first end can conveniently be attached to an electric drill and the electric drill operated to cause rotation of the drive shaft 12. In variant embodiments, the first end 12a is configured for attachment to other tools or devices operable to cause the drive shaft 12 to rotate. In other embodiments that are not shown, the sawing device includes an integrated motor, for example an electric motor, operable to drive rotation of the drive shaft 12.

The housing 14 has a central aperture extending therethrough, through which the first end 12a of the drive shaft projects. The support structure also includes a drive shaft support bush 28a and an annular bearing assembly 28b. The housing 14 has an annular recessed portion 14a around the central aperture. A cylindrical portion of the third frame portion 16c extends in the annular recessed portion 14a lengthwise with the drive shaft 12. The drive shaft support bush 28a is located and retained in the cylindrical portion 17. The second frame portion 16b provides a circular aperture in which the annular bearing assembly 28b is located. The central aperture in the housing 14 and the circular aperture are aligned such that the drive shaft support bush 28a and the annular bearing assemblies 28b are aligned. The drive shaft support bush 28a and the annular bearing assemblies 28b are configured to retain the drive shaft 12 so that its central axis is in a fixed position relative to the support structure and so that the drive shaft 12 can freely rotate about its central axis. The drive shaft 12 also has a first circumferential flange 12c that is located flush against an annular end flange of the drive shaft support bush 28a.

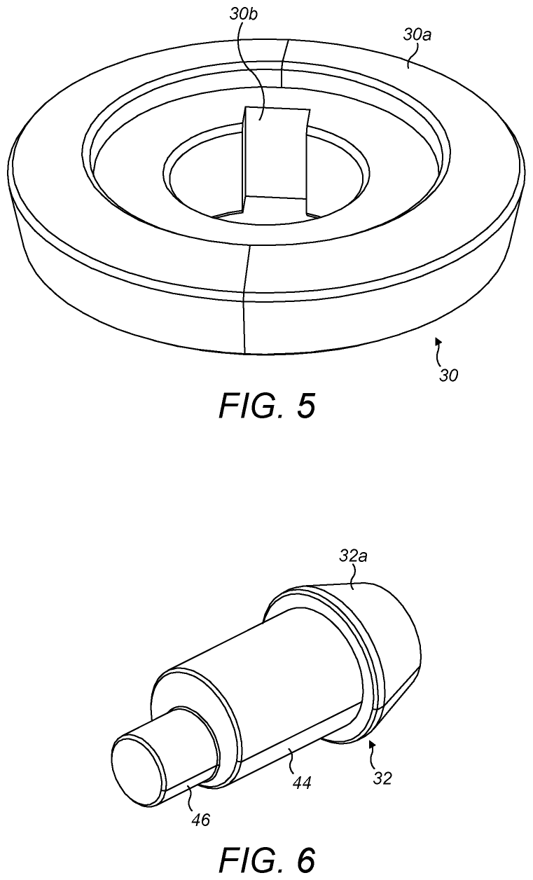

The first motion conversion assembly is in the form of a bevelled gear assembly that comprises a first part in the form of a bevelled first gear 30, indicated in FIG. 5, and four second parts each in the form of a bevelled second gear 32 one of which is shown in FIG. 6. The first gear 30 is coaxially coupled to the rotary drive shaft 12 such that rotation of the drive shaft 12 about a central axis thereof causes rotation of the first gear 30. In variant embodiments (not shown), the first gear 30 is not coaxially coupled, but is offset such that the central axis of the first gear 30 is parallel to the central axis of the drive shaft. In this case, the first gear 30 and the drive shaft 12 are coupled so that rotational motion of the drive shaft 12 about its central axis causes rotational motion of the first gear 30 about its axis. Such coupling may be achieved, for example, with a pair of meshed spur gears.

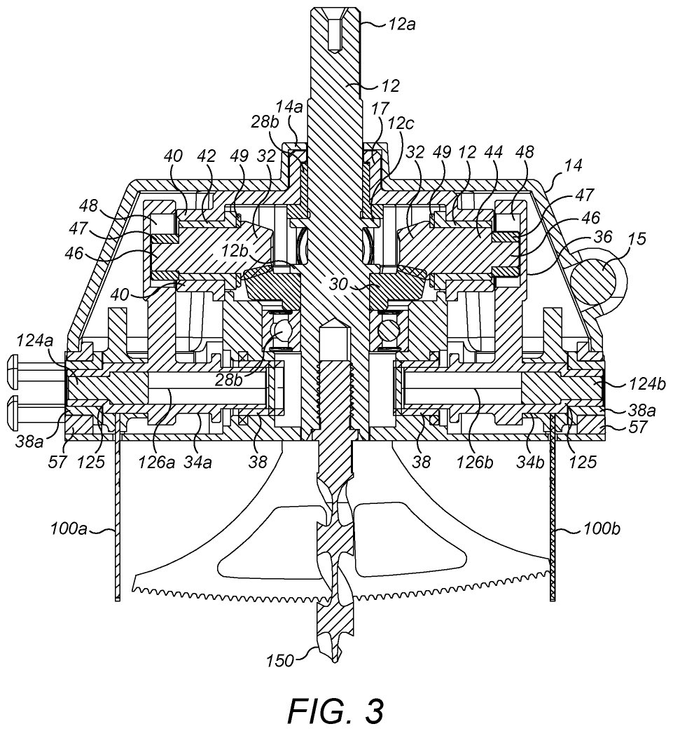

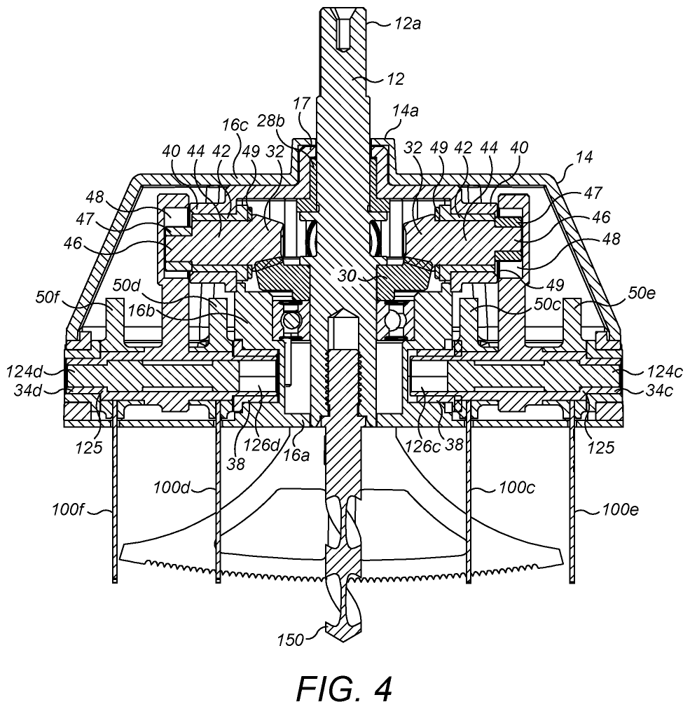

As can be seen in FIGS. 3 and 4, the first gear 30 is held in place against the annular bearing assembly by a second circumferential flange 12b extending from the drive shaft 12 to prevent axial movement. The first and second circumferential flanges 12c,b are also spaced on the drive shaft 12 to prevent axial movement of the drive shaft 12. Although it cannot be seen in the Figures, the drive shaft 12 has a radially projecting portion configured to engage in a recessed portion 30b of the first gear 30 preventing relative rotation.

Each second gear 32, indicated in FIG. 6, is mounted on the third frame portion 16c for rotation about a respective central axis thereof and such that the central axis of each second gear 32 is radial to the central axis of the first gear 30. The second gears 32 are also angularly equally spaced around the central axis of the first gear 30. Although not visible in the Figures, a bevelled surface 30a of the first gear 30 and the surface 32a of the second gear 32 are configured with teeth so that the surface 30a meshes with the surface 32a. The central axis of each second gear 32 is perpendicular to the central axis of each adjacent one of the first gears 30. Rotation of the first gear 30 causes rotation of all of the second gears 32. Thus, the bevelled gear assembly converts rotational motion of the drive shaft 12 to rotational motion of the four second gears 32 about axes radial to the central axis of the drive shaft 12 and the central axis of the first gear 30.

To support the second gears 32, the third frame portion 16c includes four cylindrical gear mount portions 40. Each cylindrical gear mount portion 40 has a respective gear mount bush 42 mounted in it.

Each second gear 32 is mounted on a cylindrical body 44 and extends from it, where the cylindrical body 44 is coaxial with the second gear 32. The cylindrical body 44 is mounted in the gear mount bush 42 such that the cylindrical body 44 and thus the second gear 32 can freely rotate about their central axis. A washer 49 is located on each cylindrical body 44 separating an annular end flange of the respective gear mount bush 42 and the respective second gear 32. Each cylindrical gear mount portion 40 is disposed and the respective second gear 32 is mounted so that the bevelled surface 32a of each second gear 32 interfaces with the bevelled surface 30a of the first gear 30, such that axial rotation of the first gear 30 causes axial rotation of each second gear 32. In the embodiment, the second gear 32 and the respective cylindrical body 44 are formed of a single piece of material, but this need not be the case. They could be separately formed and secured together.

The second motion conversion assembly comprises four pivot pieces in the form of first, second, third and fourth sleeves 34a-d. The second frame portion 16b includes four side walls in a square formation, with each side wall thereof parallel to a side edge of the base 16a. Each side wall has an aperture therein and the support structure includes four sleeve mount bushes 38. Each sleeve mount bushes 38 is located in a respective one of the apertures in the side walls. An end of each of the sleeves 34a-d is located in a respective one of the sleeve mount bushes 38.

The support structure also includes, for each sleeve 34a-d, a sleeve mount plate 57. Each sleeve mount plate 57 is fixed to a respective portion 55 of the base 16a projecting lengthwise with respect to the drive shaft 12 and spaced therefrom. Each portion 55 has threaded apertures therein and the respective sleeve mount plate 57 has aligned apertures, enabling the fixing by bolts. Each sleeve mount plate 57 has an aperture 43 therein in which a respective further sleeve mount bush 38a is located.

Each sleeve mount bush 38 and the respective further sleeve mount bush 38a are configured to receive and support a respective end of the sleeve 34a-d so that the sleeve extends radially with respect to the central axis of the drive shaft 12, while permitting at least part rotational motion, that is, oscillating movement of the respective sleeve 34a-d about a central axis thereof.

Each second motion conversion assembly also comprises a motion conversion member in the form of a pivot arm 36 fixedly mounted on the respective sleeves 34a-d, respectively. Each of the first, second, third and fourth pivot arms 36 includes a cam follower means in the form of an elongate recessed portion 48.

As seen in FIG. 6, each second motion conversion assembly also comprises a cam member 46 extending from an end of each cylindrical body 44 remote from the second gear 32. Each cam member 46 is offset from the central axis about which the respective second gear 32 and the cylindrical body 44 rotates. Each cam member 46 has an annular bush 47 over it. Each cam member 46 and annular bush 47 are located in a corresponding one of the recessed portions 48. Each recessed portion 48 and the associated cam member 46 are shaped so that rotation of the cam member 46 about the central axis of the second gear 32 and the cylindrical body 44 causes the cam member 46 to push the annular bush 47 alternately on opposite interior side wall surfaces of the recessed portion 48. Each pivot arm 36 thus follows the respective cam member 46 by pivoting about the central axis of the respective sleeve 34. Pivoting motion of each pivot arm 36 causes corresponding part rotational motion of the respective sleeve 34.

The first gear 30 and the second gears 32 are straight bevel gears. However, embodiments of the invention are not limited to such. Alternatively, the gear assembly may comprise the first and second gears 30, 32 in other forms such as spiral bevel gears, zerol bevel gears, or hypoid gears. In the embodiment the central axes of the second gears 32 extends radially with respect to the central axis of the first gear 30; however where the bevelled gear assembly comprises hypoid gears, as will be appreciated by the skilled person, the central axes of the second gears 32 do not extend radially but rather extend substantially tangentially of the first gear 30.

In other embodiments, the gear assembly may not comprise bevel gears, but may instead comprise another kind of gear assembly coupled to the drive shaft and to a rotatable part of each coupling assembly, such as the cylindrical body 44, such that rotational motion of the drive shaft causes rotational motion of each such part. For example, a face worm gear arrangement may be provided for this purpose, or the first gear may be in the form of a crown gear configured to mate with the second gears in the form of second spur gears.

In yet other embodiments, the first motion conversion assembly is not a gear assembly, but is another mechanism coupling the drive shaft 12 and the rotatable part of each coupling assembly, such that rotational motion of the drive shaft 12 causes rotational motion of each such part. Such a first motion conversion assembly may include, for example, an assembly of angular belts.

In variant embodiments, the axes of the second gears 32 may additionally extend in part lengthwise with respect to the central axis of the first gear 30. In this case the cam members 46 and the pivot members including the recessed portions 48 are modified such that rotation of the second gears results in pivoting motion of the pivot members 46. In other words, it is not essential that the central axes of the second gears 32 extend in a plane perpendicular to the central axis of the first gear 30.

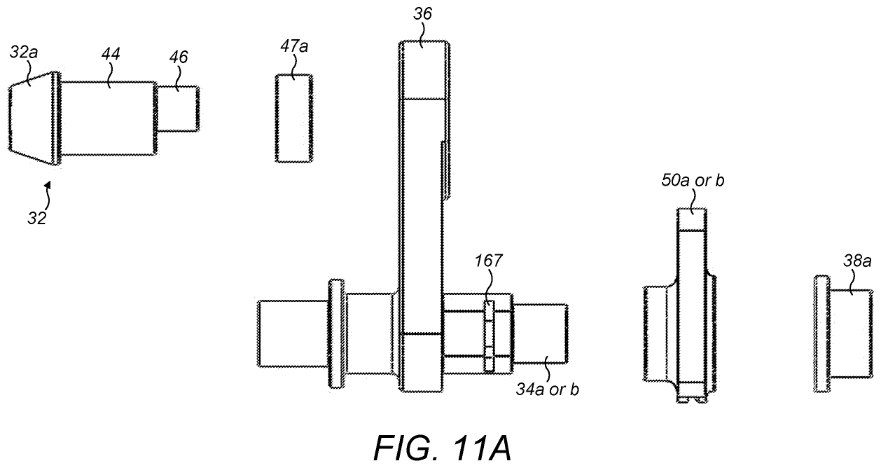

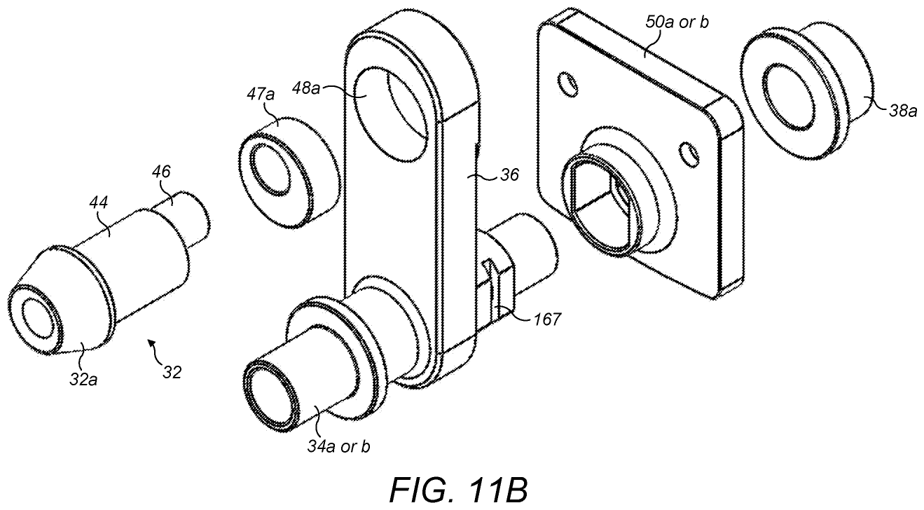

In variant embodiments, rotational motion of each second gear 32 need not be converted to oscillatory motion of the respective pivot arm using an assembly of the cam member 46, the bush 47 and the elongate recessed portion 48 shown. With reference to FIGS. 11A and 11B, in a variant embodiment the recessed portion 48a is not elongate, but is instead circular, and the bush 47a is not a regular annulus, but has a circular circumference and an aperture therethrough offset from a central axis of the bush 47a. The cam member 46 projects into the aperture. The cam member 46, the bush 47a and the recessed portion 48a are in this case configured such that, as the cam member 46 is rotated about the axis of the second gear 32 and thus the bush 47a rotates with the cam member, the bush 47a stays in contact with the interior surface of the recessed portion 48a. This reduces vibration.

In variant embodiments, the cam member and the cam follower means may take other forms. In one such embodiment, the cam member may be in the form of an elliptical cam extending from the end of the cylindrical body 44, mounted such that a centre axis thereof is offset from the centre axis of the second gear 32, and located in a modified recessed portion. In another variant embodiment, a recessed portion may be provided in the end of the cylindrical body 44 and a projection provided on the pivot arm. In this case, the elongate recess is shaped such that rotation of the cylindrical body 44 causes the elongate recess to push the projection from side to side, thereby causing pivoting of the pivot arm 36. Embodiments of the invention are not limited to any particular way in which the rotational motion of each of the second gears 32 is converted to pivoting motion of the pivot arms 36.

As already mentioned, the sawing device has six blade retention assemblies providing six places at which a one of the blades 100a-f can be attached. A first 50a of the blade retention assemblies is mounted on the first sleeve 34a, a second 50b of the blade retention assemblies is mounted on the second sleeve 34b, third 50c and fifth 50e of the blade retention assemblies are mounted on the third sleeve 34c, and fourth 50d and sixth 50f of the blade retention assemblies are mounted on the fourth sleeve 34d. Each of the blade retention assemblies 50a-f is configured so that a blade can be attached and removed via a respective slit 52a-f in the base 16a. The first, second, third and fourth blade retention assemblies 50a-d are arranged at regular intervals around and equally spaced from the central axis of the first gear 30, as first and second opposing pairs, the first pair comprising blade retention assemblies 50a,b, and the second pair comprising blade retention assemblies 50c,d. Four blades, when attached to the first and second pairs of blade retention assemblies, are disposed as two pairs (100a, 100b; 100c, 100d) of parallel blades, the pairs being mutually perpendicular, so that the sawing device can be used to cut a substantially square arrangement of cut lines. These four blades are the same length (“first length”), the length being such that a square arrangement of cut lines can be produced.

In addition to the four blade retention assemblies arranged at regular intervals, a third pair 50e,f of the six blade retention assemblies, comprising the fifth and sixth blade retention assemblies 50e, f is located further away from the first gear 30 than the second pair of blade retention assemblies. Each of the fifth and sixth blade retention assemblies 50e,f is configured so that an attached blade is disposed perpendicular to blades held by the first pair of blade retention assemblies 50a,b. Each of the blade retention assemblies 50e,f of the third pair holds, in use, a blade of the first length. When the blade retention assemblies 50e,f of the third pair are used, no blades are attached to the second pair of blade retention assemblies and a blade having a second length, longer than the first length, is attached to each of the first pair 50a,b of blade attachment assemblies. The second length is such that the formation of blades of the first length attached to the third pair 50e,f of blade retention assemblies and the blades of the second length attached to the first pair of blade retention assemblies 50a,b allows the sawing device to be used to cut a substantially rectangular arrangement of cut lines.

The first pair of blade retention assemblies 50a,b are mounted on the first and second sleeves 34a,b and the second and third pairs of blade retention assemblies 50cf are mounted on the third and fourth sleeves 34c,d, such that part rotational movement of the first, second, third and fourth sleeves 34a-d about a respective central axis thereof causes corresponding pivoting movement of the blade retention assemblies 50a-f and the blades. Each sleeve 34a-d has a respective pin 54a-d therein.

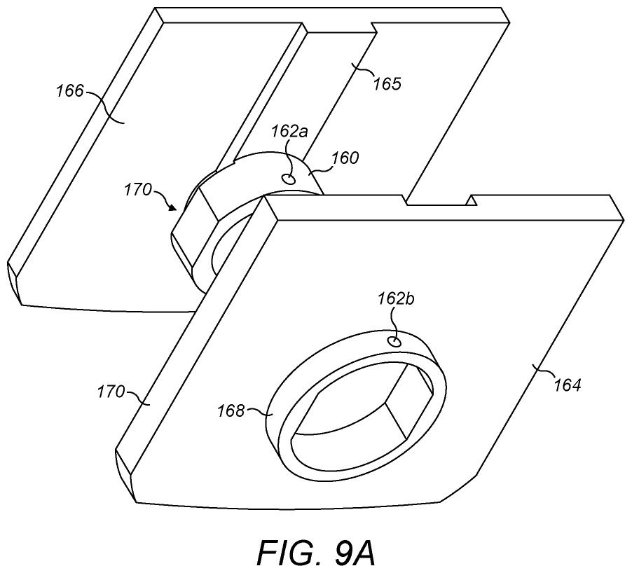

The blades will now be described in detail with reference to FIG. 8, which shows an example of the first blade 100a of the first length suitable for attachment to each of the blade retention assemblies 50e,f of the third pair when a rectangular formation of cut lines is wanted, or to each of the blade retention assemblies 50a-d of the first and second pairs when a square formation of cut lines is wanted. The longer blade 100b has an identical attachment part.

The blade 100a comprises a planar, rigid piece of uniform thickness, having a first end having a convexly curved, serrated cutting edge 102, and a second end in the form of an attachment part 104. The cutting edge 102 and the attachment part 104 are coupled by a shank portion 106. The shank portion 106 has a pair of cut out portions 109 in the blade, to save on material and reduce weight.

The attachment part 104 comprises first and second limbs 108a,b that extend away from the cutting edge 102. More specifically, the first and second limbs 108a,b extend away from a central region 102a of the cutting edge 102 in a crosswise manner. That is, a direction in which the first and second limbs 108a,b extend is substantially transverse relative to a tangent to the cutting edge 102 at the central region 102a.

The attachment part 104 also includes a base portion 110 joining the limbs 108a,b. Each limb has an outer edge 112a, 112b defining a width for the attachment part. These outer edges 112a, 112b are straight and parallel, but they might alternatively be sloped with the attachment part 104 tapering away from the cutting edge 102. Generally, the interior space of each of the blade retention assemblies is dimensioned so that the blade can be inserted into the interior space but cannot move laterally. Thus, the defined width may be the same width as the width of the interior space of the blade retention assembly, such that movement in the direction of the width is prevented. This is not essential in embodiments, since the shoulder 165, described below, may additionally or alternatively prevent lateral movement.

The limbs 108a,b define a pin-receiving space between them the purpose of which is attaching the blade 100a,b to the blade retention assemblies 50a-f so that the attached blade does not come loose. The pin-receiving space comprises three regions. A first region 114 includes a mouth between free ends of the limbs 108a,b. The first region 114 also has a first width defined by a distance between parallel portions of interior side edges of the limbs 108a,b, except at the mouth where the free ends of the limbs 108a,b are bevelled. A second region 116 is formed of opposing concave recesses in interior side edges of the limbs 108a,b. The concave recesses are part-circular in curvature. Although the width of second region varies, its width (“second width”) is greater than the first width. A third region 118 is provided by another portion of the limbs 108a,b and the base portion 110. A length of the pin-receiving space extends away from a mid-point of the cutting edge.

The cutting edge 102 is shaped so that, when the saw blade is oscillated about a pivot point in the attachment part 104, to cut into a flat surface, a cut line of substantially uniform depth is formed. The pivot point is in a centre of a notional circle of which the sides of the second recess 116 form part. A predetermined angle over which the blades are oscillated in a rocking action about the pivot point may be 12 degrees. This is 6 degrees to each side of a line orthogonal to the flat surface. An axis of the associated pin 54a-d extends through the pivot point. In embodiments, the predetermined angle may be at least 9 degrees, preferably at least 10 degrees and more preferably at least 11 degrees. The predetermined angle may be less than 15 degrees, preferably less than 10 degrees, and more preferably less than 13 degrees. The curvature of the blades is configured dependent on the predetermined angle so that the depth cut is uniform.

The first and second lengths of the saw blades may be configured dependent on the size of an aperture that it is desired to cut. The length of the saw blades may be at least 48 mm or at least 68 mm, or at least 95 mm or at least 128 mm. In some embodiments, the first length of the saw blade may be 68 mm to 70 mm, or 48.5 mm to 50.5 mm, and the second length may be 128 mm to 130 mm, or 95 mm to 97 mm, for example. Such lengths may be suitable for cutting holes in plasterboard to enable access to electrical boxes. The first and second lengths, and the sawing device, may be configured to cut holes for ventilation shafts or air conditioning units. The length of the cut line is typically approximately 6 mm greater than the length of the respective saw blade; thus each blade extends approximately 3 mm to either side in use.

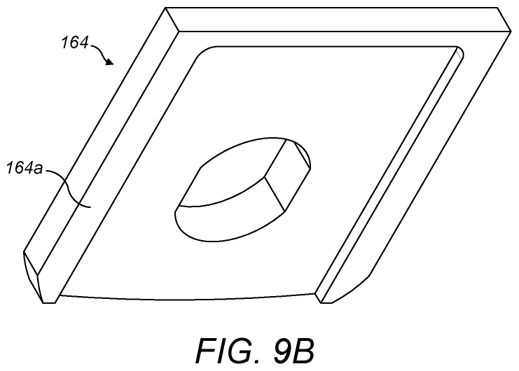

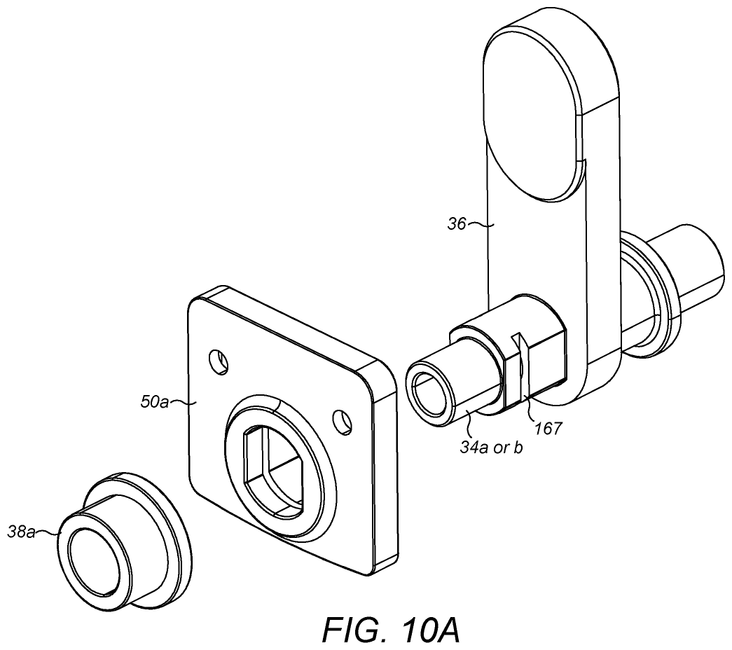

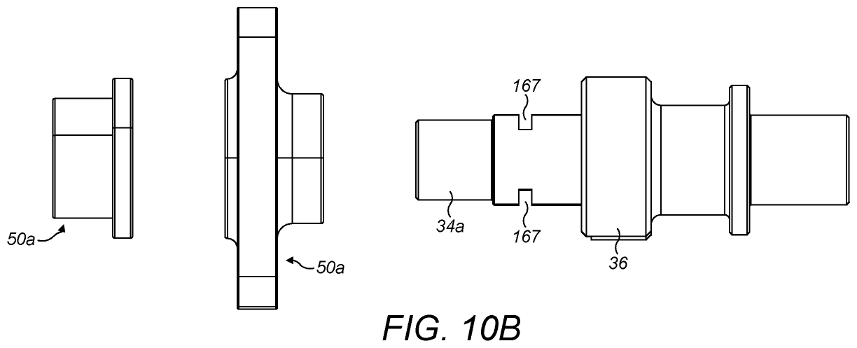

Referring to FIGS. 9A and 9B, each blade retention assembly 50a-e comprises a first plate part 166 and a second plate part 164 fixed together to define an interior space into which the limbs 108a,b of a blade 100a-f can be located. In FIGS. 10A and 10B and previous Figures the first plate part 166 and the second plate part 164 are formed of a single piece of material, but FIGS. 9A and 9B are referred to for explanatory purposes although slight variation may exist between the two versions shown.

The plate part 164 has a spacing wall 164a extending so that when the respective second plate part 164 is fixed to the first plate part 166, the two parts are not flush and the interior space is defined. The dimensions of the interior space of each blade retention assembly are such as to prevent lateral movement when the attachment part of the blade 100a-f is inserted. The spacing of the first and second plate parts 164, 166 prevents movement lengthwise with respect to an axis of the respective sleeve. A shoulder 165 extending from the second plate part 166 has a width corresponding to the first width of each blade. The shoulder 165 is located in the first region of a retained blade. This prevents rotational movement of a retained blade relative to the plate parts 164, 166 about the central axis of the respective sleeve 34a-d.

A tubular portion 160 extends from the first plate part 166 and has a circular interior cross-section shaped for location around the respective sleeve. Another tubular portion 168 extends from the second plate part 164 and is located over the tubular portion 160. The tubular portions 160, 168 provide apertures 162a, 162b that enable the first and second plates 164, 166 to be secured together by a bolt (not shown).

The tubular portion 160 is configured to provide a pair of recesses 170 on either side thereof enabling the attachment part of a blade to be slid between the tubular portion 160 and the interior surface of the first plate part 166.

Each blade retention assembly 50a-e aligns with a respective slit 52a-f in the base 16a such that an attachment part of a blade can be inserted between the first and second plate parts 166, 164. Each sleeve 34a,b has a pair of sleeve slits 167 and each sleeve 34c,d has two pairs of sleeve slits 167, the sleeve slits 167 aligning with the slits 52a-f in the base 16a and aligned with the recesses 170. Each blade retention assembly 50a-e is configured so that the limbs 108a,b cannot be located over the respective sleeve 34a-d other than by a portion of the limbs passing through the sleeve slits 167 and one of the limbs being slid along each side of the shoulder 165. The portion of the limbs 108a,b that passes through the sleeve slits 167 includes the opposing inner edges of the limbs 108a,b defining the first region 114. The diameter of the sleeves 34a-d is generally greater than the first width defined between the opposing inner edges of the limbs 108a,b, but, where the sleeve slits 167 are present, the respective sleeve 34-d presents a width slightly less than the first width. When located through the sleeve slits 167, the inner edges defining the first region 114 pass through the inside of the respective sleeve 34a-d. An internal diameter of the sleeve 34a-d corresponds to the diameter of the part-circular edges defining the second region 116.

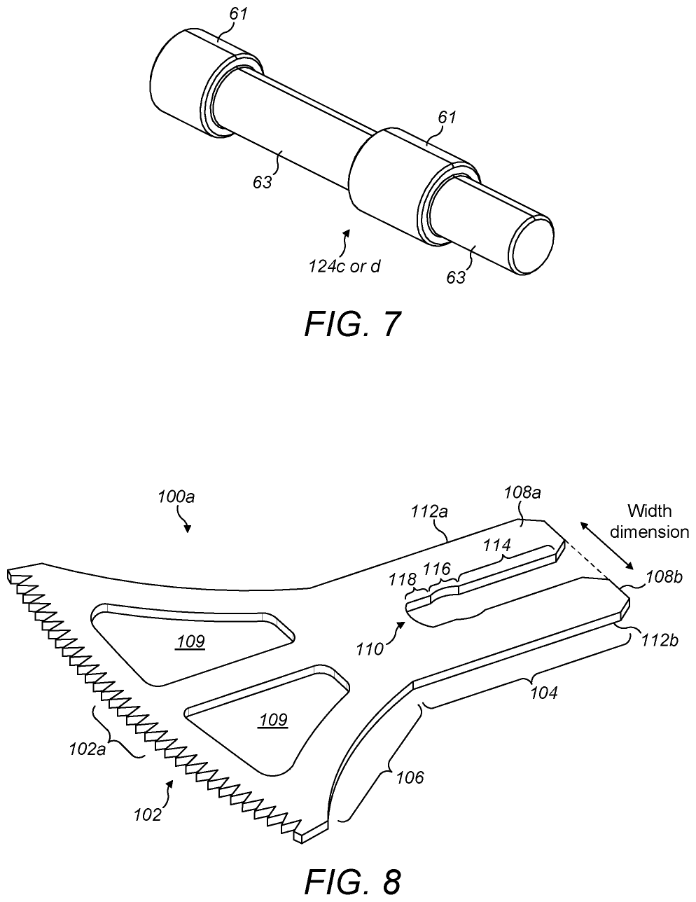

Each sleeve 34a-d has a respective pin 124a-d that is moveable therein between a blocking position in which a retained blade 100a-f is secured and an open position in which a blade can be attached or detached. The pins 124a-d are cylindrical in cross-section and have first and second portions of different diameters. The first portion 61, which has a larger diameter, is of a diameter that corresponds with the internal diameter of the sleeves. When a blade is located such that the second recess 116 and the interior cylindrical surface of the respective sleeve 34a-d are aligned, the pin 124a-d can be located in a blocking position in the sleeve with the first portion 61 located in the second recess 116. When the first portion 61 is in this position, the blade cannot be removed by pulling of the blade 100a-f away from the sawing device longitudinally with respect to the first and second limbs 108a,b, since the diameter of the first portion 61 is greater than the width of the first region 114 of the blade. If a blade is not attached, no blade can be attached when the pin 124a-d is in the blocking position since the limbs 108a,b cannot be located through the sleeve slits 167 as the first portion 61 blocks passage of the limbs. The first portion 61 is located along two portions on sleeves 34c,d, indicated in FIG. 7, so that one of these can be located to prevent attaching or detaching of a blade at each of the two pairs of sleeve slits 167 on those sleeves 34c,d.

When the pin 124a-d is in the open position, a second portion 63 of the pin 124a-d, which has a smaller diameter, is located between the sleeve slits 167, so the limbs 108a,b can be located though the sleeve slits 167 of the respective sleeve 34a-d. The blade 100a-f can then be fixed in position by movement of the pin 124a-d into the blocking position.

When a blade is attached, a part of the corresponding sleeve 34a-d occupies the third region 118 between the limbs 108a,b. Although not essential, the part of the sleeve 34a-d and the base of the attachment part abut for stability of the blade. The third region 118 is also shaped with respect to the sleeves to define a maximum extent to which the attachment part is inserted.

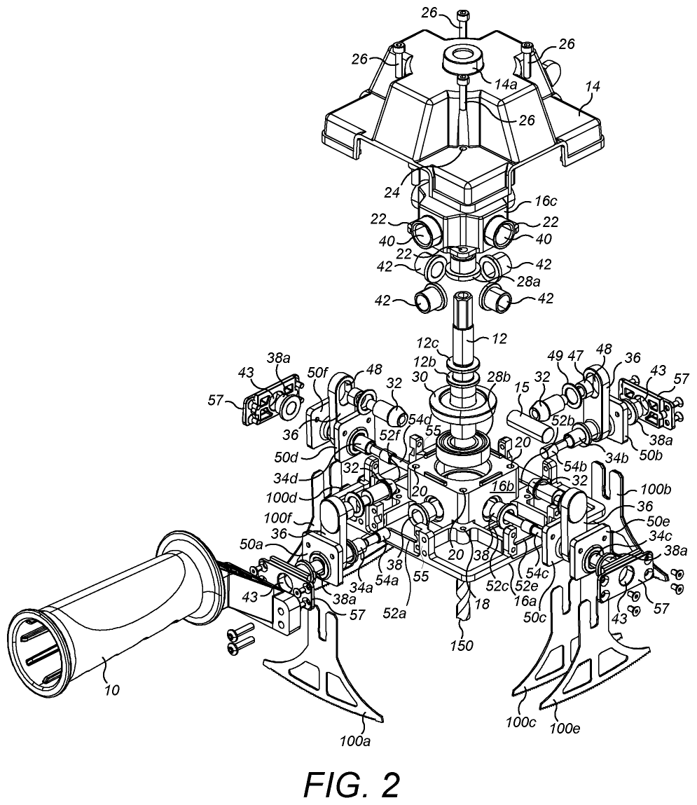

A resilient means in the form of a spring 126a-d (not shown in FIG. 2) is located in each sleeve 34a-d, to bias each pin 124a-d into the blocking position. Each spring 126a-d is located in the respective sleeve 34a-d between an end surface of the respective sleeve mounts bush 38 in the support structure and an end of the respective pin 124a-d. A shoulder 125 in the interior of each sleeve 34a-d abuts against the first portion 61 of the respective pin to retain that pin 124a-d in the sleeve 34a-d against the corresponding spring 126a-d. Each pin 124a-d may be pushed using a pointed tool through the corresponding aperture 43a-d to move the pin from the blocking position to the open position against the spring, thereby to enable release or attachment of a blade.

In operation of the sawing device, the drive shaft 12 causes the first gear 30 to rotate. The rotation of the first gear 30 causes rotation of each of the second gears 32 each about its respective central axis in a particular direction of rotation. Rotation of each second gear 32 causes rotation of the respective cam member 46 in the recessed portion 48 of the respective pivot arm 36. The cam member 46 pushes the pivot arm side-to-side repetitively, that is, the pivot arm 36 pivots repetitively about the central axis of the respective sleeve 34a-d. Oscillating movement of the pivot arm also results in oscillating movement of the blade retention assemblies 50a-f about the central axis of the corresponding sleeve 34a-d, thereby causing attached blades to oscillate back and forth in a cutting action.

To remove a blade from one of the blade retention assemblies 50a-f, the corresponding pin 124a-d is first pushed into the corresponding sleeve 34a-d against the spring 126a-d to move the pin 124a-d in the sleeve 34a-d from the blocking position, to the open position. The blade can then be removed from the blade retention assembly 50a-f by pulling of the blade away from the sawing device longitudinally relative to the limbs 108a,b. The first region 114 of the space between the limbs 108a,b then passes through the corresponding sleeve 34a-d and is detached. When released, the pin 124a-d returns to its initial, blocking position through action of the spring 126a-d.

To attach another blade, the pin 124a-d is again pushed so that the first portion 61 of the pin 124a-d is not between the sleeve slits 167 and the second portion 63 is. The limbs 108a,b can then be inserted into the interior space of the blade retention assembly, with a portion of the limbs passing through the sleeve slits 167 and the cylindrical interior of the sleeve 34a-d. The blade attachment part is then pushed until the base 110 of the blade abuts the sleeve 34, such that a part of the sleeve occupies the third region 118. The base of the blade 110 and the second region 116 are spaced so that, when the base abuts the sleeve, the second region 116 is positioned relative to the pin 124a-d so that on release of the pin 124a-d, the pin 124a-d returns to its blocking position extending through the second region 116, where the pin prevents detachment of the blade. This spacing facilitates insertion of the blade and prevents the blade being pushed in too far.

A drill bit attachment is coupled to or integrally formed with the drive shaft 12, such that an attached drill bit 150 extends from the underside of the sawing device. An aperture in the base 16a is provided to allow this. Thus, when the blades are pressed against the surface, the drill bit pierces the surface in a region to be cut out, thereby to anchor the cutting. This anchoring of cutting using a rotating drill bit advantageously makes use of the presence of the drive draft.

The convexly curved blades are highly advantageous for several reasons. They clear dust from a cut line like a circular saw, while producing cut lines of uniform depth. The curved blades also result in an array of cut lines being easy to produce with little force required by an operator to push the blades into a surface to be cut. In prior art cutting devices in which linear blades are used, there exists a problem that the devices bounce off the surface to be cut. This problem may be at least partially addressed with the pilot drill. However with the sawing device of the embodiment described above, the pilot drill is typically only of value where hard boards are being cut, or where the operator is new to the tool. The operator may not attach the drill bit 150.

The sawing device may be formed of conventional materials. For example most or all of the components mentioned above may be formed of aluminium and/or steel.

The sawing device includes a spirit level 15 parallel to blades 100a, 110b to aid the user when cutting a vertically disposed piece of material.

It will be appreciated by persons skilled in the art that various modifications are possible to the embodiments.

The sawing device described above allows attachment of a blade at six attachment places, so that, when blades of appropriate length are attached at the appropriate attachment places, the sawing device can be operated to cut lines in a square formation or a rectangular formation. In an alternative embodiment, the sawing device is configured with four blade attachment assemblies only, allowing attachment of the blades at only four places. In this case, cut lines in a square or a rectangular formation can be cut into the surface of an object to be cut.

As will be appreciated, the number of second gears 32 that may be rotated by the first gear 30 is not limited to four. Two or three only may be present in alternative embodiments, with associated coupling assemblies. Thus, the sawing device may be configured to oscillate two parallel blades, for example, or three blades in a triangular formation. In other embodiments, greater than four second gears 32 and associated coupling assemblies may be present. For example, five, six, seven or eight may be present. Where the blades are equally spaced from the central axis of the first gear 30 and the angular spacing around the central axis is also equal, this would result in a sawing device capable of cutting a pentagonal, hexagonal, heptagonal or octagonal array of cut lines. In variant embodiments an even greater number of second gears and associated coupling assemblies may be present. The blades need not be equally spaced from the central axis of the first gear 30, as is the case where a rectangular array of cut lines is to be cut.

Furthermore, advantages over prior art sawing devices derive from the creation of oscillatory motion, which is transmitted to the blades, together with the arcuate nature of the blade edges. Oscillatory motion may be created using second motion conversion assemblies other than that described above.

Embodiments of the invention may however include variants that include the first motion conversion assembly described above, but in which the movement of the blades is not pivoting and is in a straight line. The sawing device described above could be readily adapted by the skilled person. For example, a mechanism for reciprocating blades each in a straight line could be put into effect using the mechanism described in WO2013057511 where the mechanism is adapted to incorporate the first motion conversion assembly and the cam member and cam follower are adapted to result in linear reciprocating motion. The contents of this publication is herein incorporated by reference in its entirety.

In another variant embodiment, the second motion conversion mechanism and blade retention assemblies may be absent and instead each second gear 32 may be coupled to a respective circular saw blade so that rotation of the second gear 32 in a direction causes rotation of the respective circular saw blade about a central axis of the circular saw blade in a direction. In this case, the central axis of the circular saw blade may be the same as the axis of the send gear 32. Alternatively, the circular saw blade and the corresponding second gear may be coupled such that rotation of the second gear causes rotation of the corresponding circular saw blade and the axes thereof are parallel, in this case the two parts being coupled by an assembly of meshed gears or belts, for example. It would be apparent to the person skilled in the art how to modify the embodiments described above to achieve this using attachment mechanisms for circular saw blades known in the art.

The part-circular recesses that define the second region 116 need not be part circular. Instead they could be of many different shapes, provided that the corresponding pin can move to a blocking position to securely attach the blade. It is also not essential for the pins and/or the sleeves to have circular cross-sections. The sleeve serves to transmit oscillatory motion and other shapes suffice to do this. Also, since cross-section of the sleeves is circular, the first portions of the pins are correspondingly shaped, but the interior shape of the sleeve and the outer shape of the pins may be different.

The sawing device described above is a hand-held device. However, it is not limited to such. The sawing device and/or parts thereof including the bevelled gear assembly, may be incorporated in a standing machine.

The applicant hereby discloses in isolation each individual feature or step described herein and any combination of two or more such features, to the extent that such features or steps or combinations of features and/or steps are capable of being carried out based on the present specification as a whole in the light of the common general knowledge of a person skilled in the art, irrespective of whether such features or steps or combinations of features and/or steps solve any problems disclosed herein, and without limitation to the scope of the claims.

1. A cutting assembly for cutting with four cutting blades simultaneously of a rectangular or square formation of cut lines, comprising:
a motion conversion mechanism comprising:
a first part arranged to rotate about a central axis thereof and coupled to a drive means for causing the rotation,
four rotatable second parts angularly spaced around the central axis of the first part, the first and second parts being arranged such that the rotation of the first part in a direction of rotation causes rotation in a corresponding direction of rotation of each second part about an axis thereof extending away from the central axis of the first part; and
for each second part, a coupling mechanism arranged to couple the second part to a respective cutting blade, such that the rotation of the second part causes back and forth cutting motion of the cutting blade,
wherein each coupling mechanism comprises a retainer arranged to retain the respective cutting blade and mounted for predetermined movement, the retainers being mounted to retain the cutting blades to cut a rectangular or square formation of cut lines,
wherein the coupling mechanism is arranged so that the rotation of the respective second part causes the predetermined movement, and the predetermined movement of the retainer imparts the back and forth cutting motion to the respective cutting blade.

2. The cutting assembly of claim 1, wherein the first part is a first gear and each second part is a second gear.

3. The cutting assembly of claim 2, wherein the first and second gears are bevel gears.

4. The cutting assembly of claim 2, wherein the first and second gears are straight bevel gears or spiral bevel gears or helical gears, or wherein the second gears are worm gears.

5. The cutting assembly of claim 1, wherein the axis of each second part extends radially to the central axis of the first part.

7. The cutting assembly of claim 6, wherein each coupling means comprises a further motion conversion means arranged to convert the rotational motion of each second part to the predetermined movement of the respective retaining means.

8. The cutting assembly of claim 7, wherein each further motion conversion means comprises a respective motion conversion member mourned for back and forth motion, wherein each coupling means also includes means linking the second part and the motion conversion member such that rotation of the respective second part causes the back and forth motion of the motion conversion member, wherein the back and forth motion of the motion conversion member causes the predetermined movement of the retaining means.

9. The cutting assembly of claim 8, wherein each linking means comprises a cam coupled to the second part for rotation therewith about the respective central axis of the second part, and each motion conversion member comprises a cam follower, wherein the cam follower and the cam are respectively arranged so that the rotation of the second part causes the back and forth movement of the respective motion conversion member.

10. The cutting assembly of claim 9, wherein the cam follower comprises a recessed portion in the motion conversion member, wherein the cam extends into the recessed portion and is configured to act on surfaces in the recessed portion to cause the back and forth motion of the motion conversion member.

11. The cutting assembly of claim 10, wherein each motion conversion member is pivotally mounted, and the back and forth motion is pivoting motion.

12. The cutting assembly of claim 11, wherein the motion conversion member is mounted for linear reciprocating motion, wherein the back and forth motion is the linear reciprocating motion.

13. The cutting assembly of claim 8, wherein each further motion conversion means comprises a respective pivot piece extending radially with respect to a central axis of the first part, wherein the respective retaining means is mounted on the pivot piece, the pivot piece being arranged to enable the predetermined movement of the retaining means, wherein the respective motion conversion member is also pivotally mounted on the pivot piece.

14. The cutting assembly of claim 1, wherein the plurality of second parts consists of two, three, four, five or six second parts.

15. The cutting assembly of claim 1, wherein the second parts are angularly spaced around the first part.

16. The cutting assembly of claim 15, wherein the second parts are each spaced around the first part at equal angles from adjacent of the second parts.

17. The cutting assembly of claim 1, further comprising the drive means, wherein the drive means comprises a drive shaft coupled to the first part, such that rotation of the drive shaft causes the rotation of the first part.

18. The cutting assembly of claim 1, further comprises a support means, wherein the motion conversion assembly and each coupling means are mounted on the support means.

20. A hand-held tool comprising the cutting assembly of claim 1.

21. A cutting assembly for cutting with four cutting blades simultaneously of a rectangular or square formation of cut lines, comprising:
a motion conversion mechanism comprising:
a first part arranged to rotate about a central axis thereof and coupled to a drive means for causing the rotation,
four rentable second parts angularly spaced around the central axis of the first part, the first and second parts being arranged such that the rotation of the first part in a direction of rotation causes rotation in a corresponding direction of rotation of each second part about an axis thereof extending away from the central axis of the first part; and
for each second part, a coupling mechanism arranged to couple the second part to a respective cutting blade, such that the rotation of the second part causes back and forth cutting motion of the cutting blade,
wherein each coupling means comprises retaining means arranged to retain the respective cutting blade and mounted for predetermined movement, the four retaining means being mounted to retain the cutting blades for cutting of a rectangular or square formation of cut lines, and
wherein the coupling means is arranged so that the rotation of the respective second part causes the predetermined movement, and the predetermined movement of the retaining means imparts the back and forth cutting motion to the respective cutting blade,
wherein the four retaining means are arranged to return the cutting blades for cutting of a rectangular or square formation of cut lines.
